(19) United States
(12) Patent Application Publication
(10) Pub. No.: US 2006/0087680 A1
(43) Pub. Date: Apr. 27, 2006

(54) Method, apparatus and program for print instruction

(75) Inventor: Toshihiro Maeda, Sakai-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Tokyo (JP)

(21) Appl. No.: 11/011,094

(22) Filed: Dec. 15, 2004

(30) Foreign Application Priority Data
Oct. 25, 2004 (JP) 2004-309201

(51) Int. Cl. G06F 15/00

(52) U.S. Cl. 358/1.15

(57) ABSTRACT

In a transmission of a print job to printers, print settings for printers are registered, and setting icons in correspondence to the print settings registered are displayed in a screen of a display device. When a file icon of a document file is detected to be drag-and-dropped onto a setting icon among the setting icons displayed in the screen. Then, a document file in correspondence to the drag-and-dropped file icon and a setting command converted from the print setting corresponded to the setting icon are transmitted as a print job to the specified printer in correspondence to the setting icon.

This application is based on application No. 2004-309201 filed in Japan, the contents of which are hereby incorporated by reference.

### BACKGROUND OF THE INVENTION

1. Field of the Invention

The present invention relates to a method and an apparatus for instructing to transmit electronic file data to a printer together with a print setting.

2. Description of the Background Art

In a system in which a printer, a computer and the like are connected to a network such as a local area network, a printing of an electronic file (or a document data) can be instructed to the printer by an application program running in the computer. For example, an icon (a shortcut) of an available printer is displayed in a desktop screen of the computer. When a printer driver for the printer is activated by dropping the document data on the printer icon, the document data created by the application is converted to print data and is transmitted. When the printer receives the print data, it performs the printing therefor.

In a system disclosed in Japanese Patent laid open Publication 11-334180/1999, a plurality of printers are connected to the network. When an icon representing a printer, a print function of a multi-functional peripheral or the like is drag-and-dropped onto an icon of a document file to be printed, the printer suitable for the printing is automatically selected, and the document is transmitted to and printed by the printer.

Some applications executed by a computer transmit a document file to a printer together with a print setting therefor without converting the document file to PDL or the like. This is called direct printing. In such a direct printing application, a printer and print setting therefor are previously registered in the application itself. When a user drag-and-drops an icon of a document file onto a setting icon for the print setting of the application provided in the desktop screen of the computer, the file is transmitted with the print setting to the printer.

However, a conventional direct printing application is not user-friendly. For example, even when a plurality of printers and a plurality of print settings can be registered, only one print setting can be registered in a shortcut of the application itself. Thus, in order to change the printer or the print setting, a user has to change it manually at the time of transmission. In addition, when the contents of the print setting once registered are changed, it is necessary to activate the application again, and to select, change and register the setting contents. Besides, the file once transmitted is transmitted again with the same print setting, the same operations as those at the time of the previous transmission have to be repeated. Meanwhile, when the print setting is changed, the original print setting is cleared unless saved, so that the original print setting cannot be used again.

### SUMMARY OF THE INVENTION

It is an object of the present invention for a user to perform the print setting easily when a printing of a document is instructed to a printer connected through the network.

In one aspect of the invention, when a print is instructed by transmitting a print job to a printer, print setting for printers have been registered, and a plurality of setting icons in correspondence to the print settings registered are displayed in a screen of a display device. When a file icon of a document file is detected to be drag-and-dropped onto a setting icon among the setting icons displayed in the screen. Then, a document file in correspondence to the drag-and-dropped file icon and a setting command converted from the print setting corresponded to the setting icon are transmitted as a print job to a specified printer in correspondence to the drag-and-dropped setting icon.

It is an advantage of the invention that the print setting becomes easy by drag-and-dropping the file icon of the document data on any setting icon.

### BRIEF DESCRIPTION OF THE DRAWINGS

These and other objects and features of the present invention will become clear from the following description taken in conjunction with the preferred embodiments thereof with reference to the accompanying drawings, and in which:

FIG. 1 is a diagram of a system in which a printer and a computer are connected to a network;

FIG. 2 is a block diagram of the computer;

FIG. 3 is a block diagram of a print instructor apparatus;

FIG. 4 is a flowchart of a processing on a setting icon;

FIG. 5 is a diagram of an example of a desktop;

FIG. 6 is a diagram of a print setting edition screen;

FIG. 7 is a diagram of a menu for print setting;

FIG. 8 is a flowchart of displaying print setting GUI;

FIG. 9 is a diagram of a menu for direct printing;

FIG. 10 is a flowchart of print setting edition menu display, setting change history menu display and job transmission history menu display;

FIG. 11 is a flowchart of print setting change;

FIG. 12 is a flowchart of print setting change history;

FIG. 13 is a flowchart of job transmission history;

FIG. 14 is a flowchart of file printing and print setting import;

FIG. 15 is a diagram of a menu of the setting change history;

FIG. 16 is a diagram of a menu of the setting change history;

FIG. 17 is a flowchart of automatic saving; and

FIG. 18 is a flowchart of print setting import.

### DESCRIPTION OF THE PREFERRED EMBODIMENTS

Referring now to the drawings, wherein like reference characters designate like or corresponding portions throughout the several views, embodiments of the present invention will be described below.

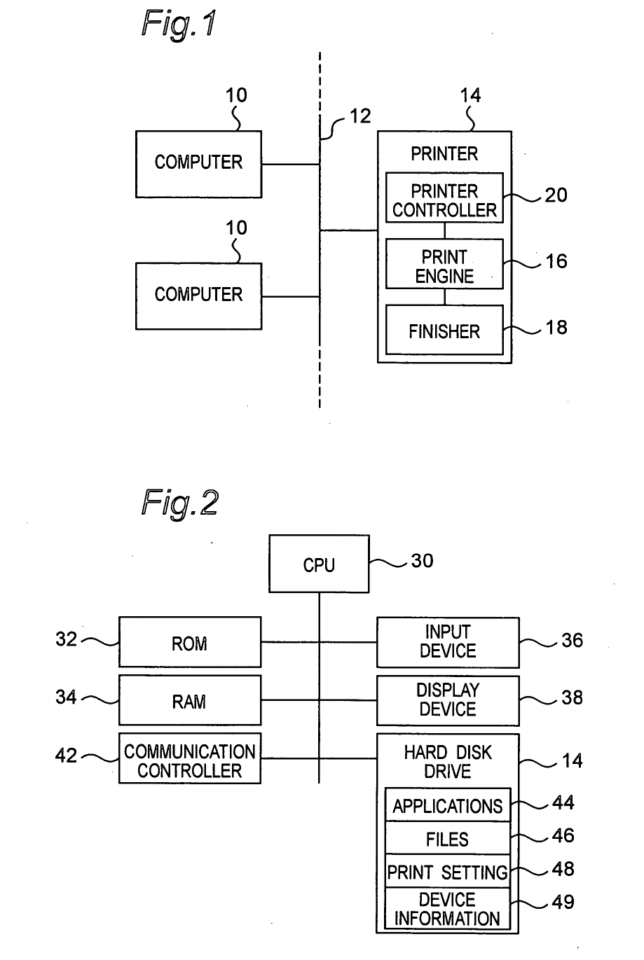

In a system shown in FIG. 1, a printer 10 is connected through a network 12 such as a local area network to a computer 10 such as a personal computer. The printer 14 may be a multifunctional peripheral (MFP) having a print function. An application program installed in the computer 10 can issue a print command to the printer 10. The printer 10 has a print engine 16 for carrying out printing on a sheet of paper, and a finisher 18 provided for finishing such as sorting (electron sorting), stapling, punching or the like. A print controller 20 controls the print engine 16 and the finisher 18.

As shown in FIG. 2, in the computer 10, a central processing unit (CPU) 30 for controlling the entire computer is connected to a read-only memory (ROM) 32 for storing a program and the like, a random access memory (RAM) 34 serving as a working area, an input device 36 such as a keyboard, a mouse or the like, a display device 38 with a display screen, a hard disk drive 40, and a communication controller 42. The hard disk drive 40 stores application programs 44 which use the printer 14 for printing, and various kinds of document files 46. Further, it stores one or more printing settings 48 and device information 49 as will be described below.

In the computer 10 a user can instruct a printing by using a setting icon in correspondence to a print setting registered. It is known that when icons of applications and files are placed on a desktop screen, a basic operation screen of the operating system, the applications and the files can be opened immediately by operating the icons thereof. In this embodiment, a user places shortcut icons to the print settings 48 themselves) previously registered in the storage device 40 in the computer 10 in the desktop, and a file 46 in a format of Word, PDF, TIFF or the like is directly transmitted to the printer 14 by using the shortcut icons. A shortcut icon is an icon which functions as a reference to a file positioned at a different place. A shortcut icon to a print setting 48 is hereinafter referred to as a setting icon. A user can start to print a file with a registered print setting by an operation for relating a setting icon to an icon of the file. For example, as an operation for the relationship, the user drag-and-drops the icon of the file onto the setting icon. In this operation, the user moves the mouse while keeping down a left button of the mouse and releases the left button at the destination. In addition, as will be described below, various kinds of functions are provided for a setting icon.

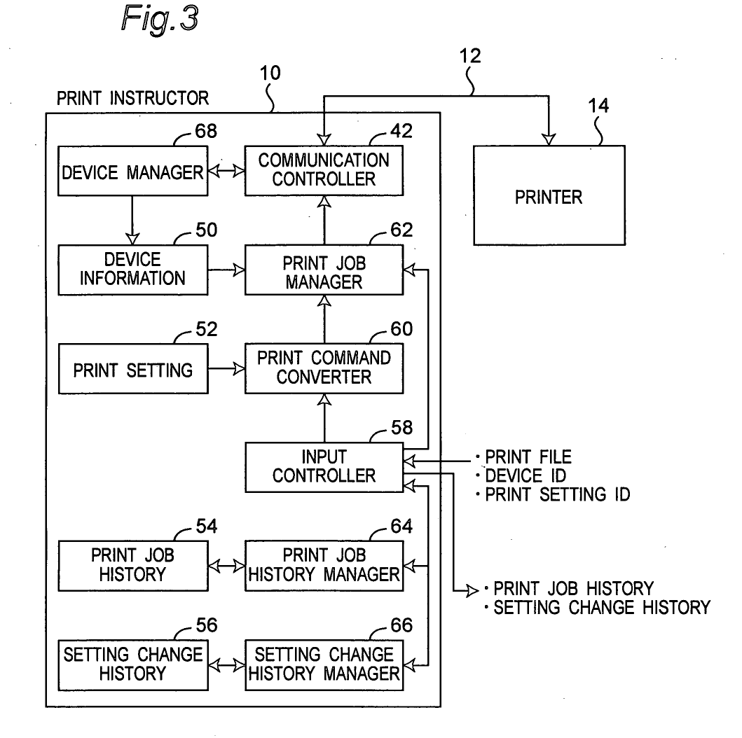

FIG. 3 is a block diagram of functions in the computer 10 used as a print instructor apparatus. The print settings 48 and the device information 49 are stored in a device information storage section 50 and in a print setting storage section 52, respectively. The device information includes IP address, a port number and the like needed for a communication for printing. The print settings include items used for special printing processes by the printer such as N in 1, double-side (duplex) printing, staple=on, one upper rightmost point, and punch=2 holes. In addition, a print job history and a setting change history are stored in a print job history storage section 54 and a setting change history storage section 56, respectively. A communication controller 42 transmits and receives data through the network 12. An input/output controller 58 receives a print file, a device ID, a print setting ID and the like and outputs the print job history and the setting change history. A device manager 68 obtains from the printer and manages the device information such as file formats supported by the apparatus and device options such as the finisher. In some cases where different communication protocols are used in different printers, the device manager 68 manages communications for the printers. In addition, the device manager 68 searches printers automatically, and the result of the automatic search is reflected in the device information.

Direct printing instructed by the print instructor apparatus will be described here. In the print instructor apparatus, the device information 49 of the printers (devices) and the print settings 48 set by users are stored in the device information storage section 50 and in the print setting storage sections 52, respectively. When file data such as a file name and its position of a file to be printed, an ID for identifying a printer and an ID for identifying a print setting are input to the input/output controller 58, a print command converter 60 converts the print setting to a command for the printer 14 for controlling a printing. It is to be noted that a previously converted command may be stored as a print setting information.

Then, the input/output controller 58 sends the device information, the print command and the print file to the print job manager 62, which sequentially transmits the print job to a target printer 14 through the communication controller 42. The data to be transmitted becomes the print file and the print command. In the printer 14, the print file is converted to raster data and printed according to the print command, and the prints are subjected to the finishing process such as stapling, punching or the like if necessary. Thus, the printing is completed.

When a printing is started, the print job manager 62 stores the ID of the used printer, the ID of the print setting, the file name, the status of the job and the print setting in the print job history storage section 54. The print setting information includes concrete contents of the print setting such as stapling or the punching. When the printing is completed, the print date, the status and the like are updated. When the print setting is changed, a setting change history manager 66 updates the setting change history in the setting change history storage section 56.

Next, printing of a file 46 in format of Word, PDR, TIFF or the like by using the setting icon is explained. Setting icons for the printers and the print settings registered previously are placed in the desktop screen of the display device 38. More specifically, the print settings for the specified printers are previously registered in the print setting storage section 52, and setting icons for the registered respective print setting are placed in the desktop. The setting icon includes the device ID for identifying a printer and a print setting. When an icon of a file is drag-and-dropped onto the setting icon, the print instructor apparatus performs a direct printing in the specified print setting in the printer 14. That is, the print setting is converted to a command or it may previously be converted to a command, so that the printer 14 can control the printing in correspondence to the setting icon onto which the icon of the file is drag-and-dropped. Thus, the setting command converted and the file not converted are transmitted as a print job to the printer 14 specified by the setting icon drag-and-dropped.

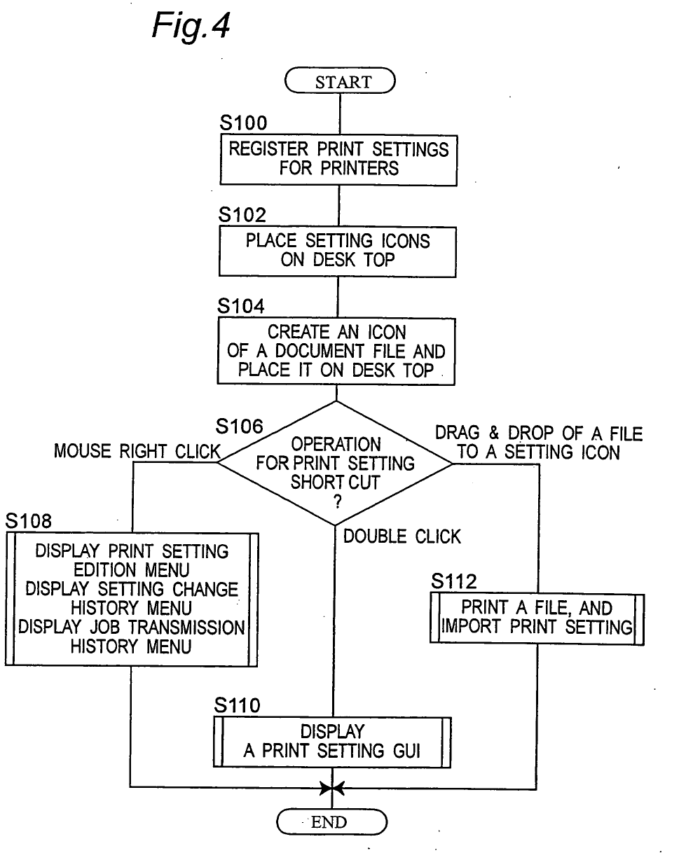

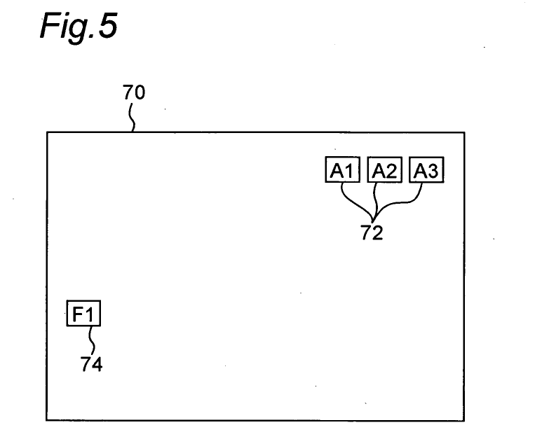

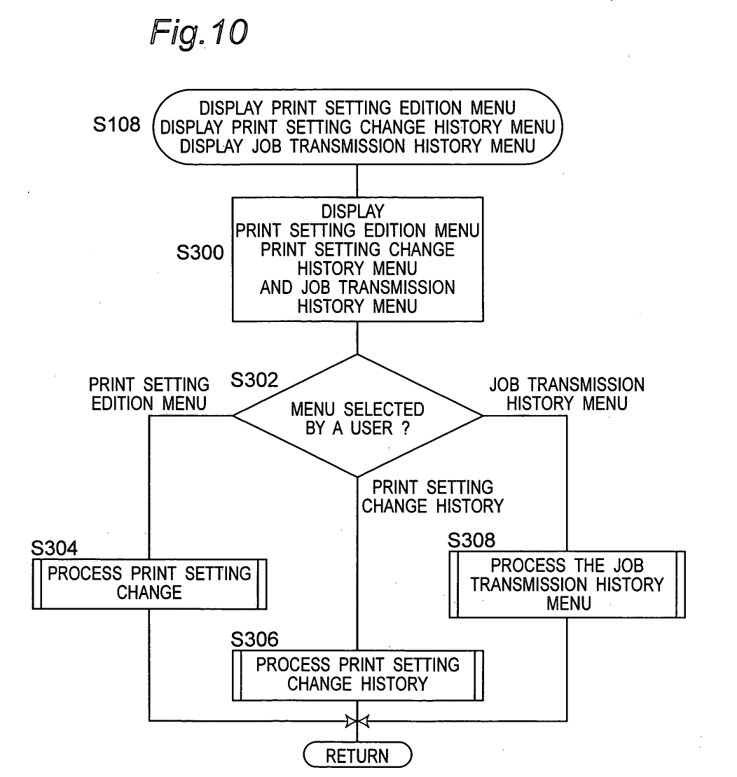

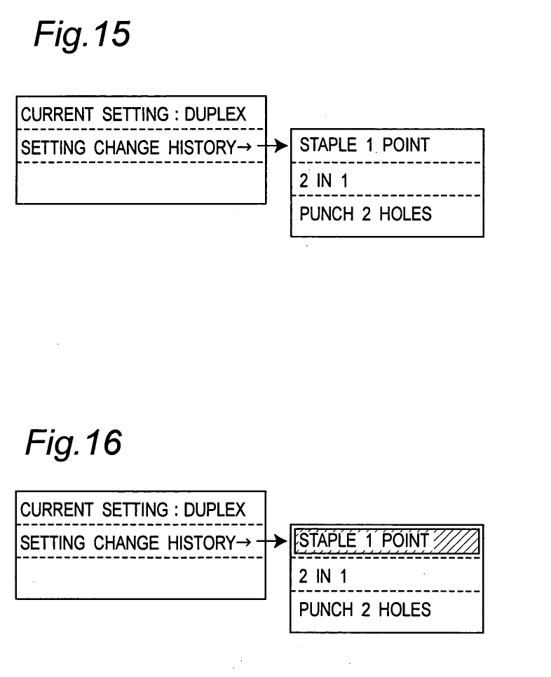

FIG. 4 shows a flow on operations for a setting icon. A user registers print settings for specified printers 14 among the printers connected to the computer 10 in the storage section 40 in the computer 10 (S100). Then, the user places a plurality of setting icons in correspondence to registered print settings in the desktop of the display device 38 (S102). In addition, the user creates an icon of a document file to be printed and places it in the desktop (S104). FIG. 5 shows an example of the desktop 70 wherein three setting icons 72 and one icon 74 of a file are placed. Here, when the user handles the mouse with a right-click, a double-click, and a drag-and-drop on a setting icon, the flow branches in correspondence to the operation on the setting icon and steps in correspondence to the respective operation are started (S106). When the user right-clicks the mouse on the setting icon, a print setting edition menu, a setting change history menu, and a job transmission history menu are displayed (S108, refer to FIG. 10). When the user double-clicks the mouse on the setting icon, a print setting graphic user interface (GUI) for editing the print setting data is displayed in the screen (S110, refer to FIG. 15). When the user drag-and-drops the mouse from a file icon to a setting icon, the file is printed or the print setting is imported (S112).

First, the processing when the mouse is double-clicked on the setting icon will be described below in detail. In this case, a screen for editing the print setting data is directly activated and can be edited.

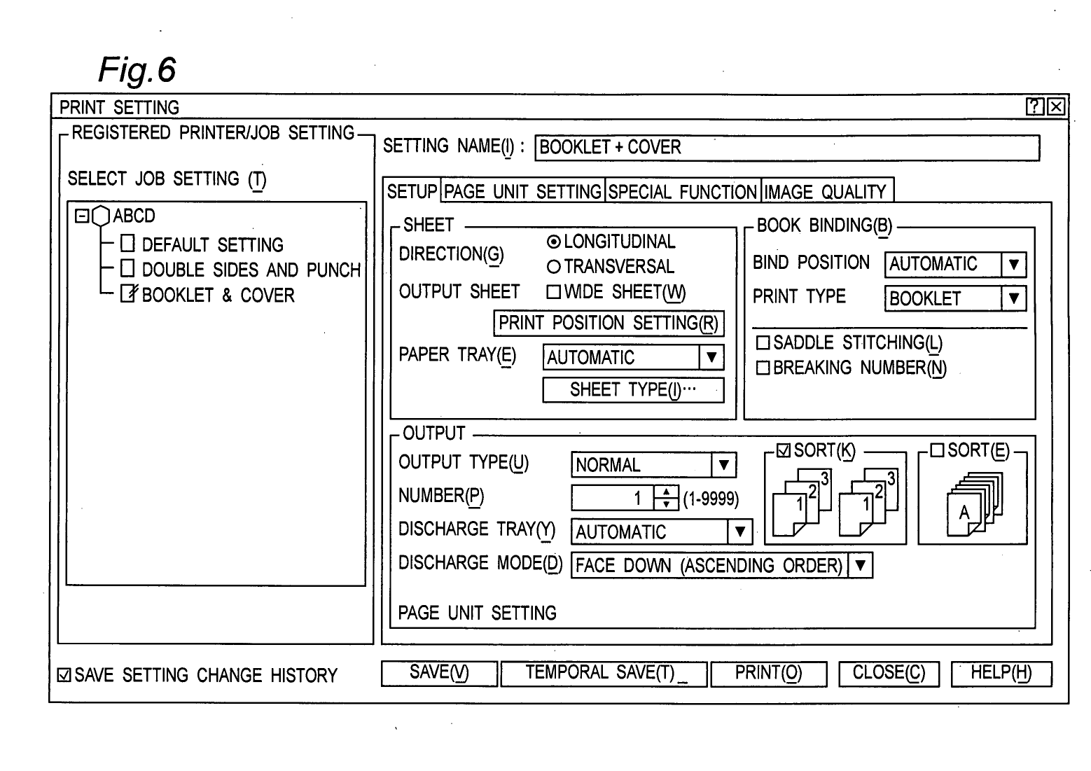

When the user double-clicks the setting icon in the desktop screen, the print setting edition screen is activated. Thus, the print setting can be edited directly and visually in the screen easily. Here, the device information and the print setting set beforehand are obtained, and they are reflected in the print setting edition screen to be displayed. In an example shown in FIG. 6, a print setting named “Booklet+Cover” is displayed in the print setting edition screen, wherein the user can set items on paper sheets such as sheet direction, output sheet, and paper feed tray, items on an output such as output method, number of copies, paper discharge tray, sheet discharge mode, sorting, and assorting, and items on book binding such as binding position and printing type. In addition, the buttons of save, temporal save, print, close, and help are arranged at the lowest part in the screen. Here, when the save button is selected, the registered print setting in correspondence to the setting icon is changed to the selected print setting data (saved), while when the temporal save button is selected, the selected information is temporally set. Here, temporal setting means that the direct printing is performed only when the document file is drag-and-dropped onto the setting icon after this edition screen is closed, but that the registered print setting is set again thereafter. In addition, when the print button is selected, the print job is transmitted. At this time, if a print file is not specified, a screen for specifying the file may be displayed.

In the above-mentioned setting change, it can be selected whether the changed print setting is used temporally only for a subsequent file printing or permanently or as a default so that the current setting is replaced therewith. Therefore, in addition to the “save” button for saving the setting as the permanent setting, the “temporal save” button is provided in the print setting edition screen for saving the setting temporally. Thus, when the “temporal save” button is pressed, the edited print setting is temporally stored. In addition, a checkbox of “save setting history” shown in FIG. 6 is provided so that a user can select to save the print setting temporarily or permanently according as a check in the checkbox is found or not.

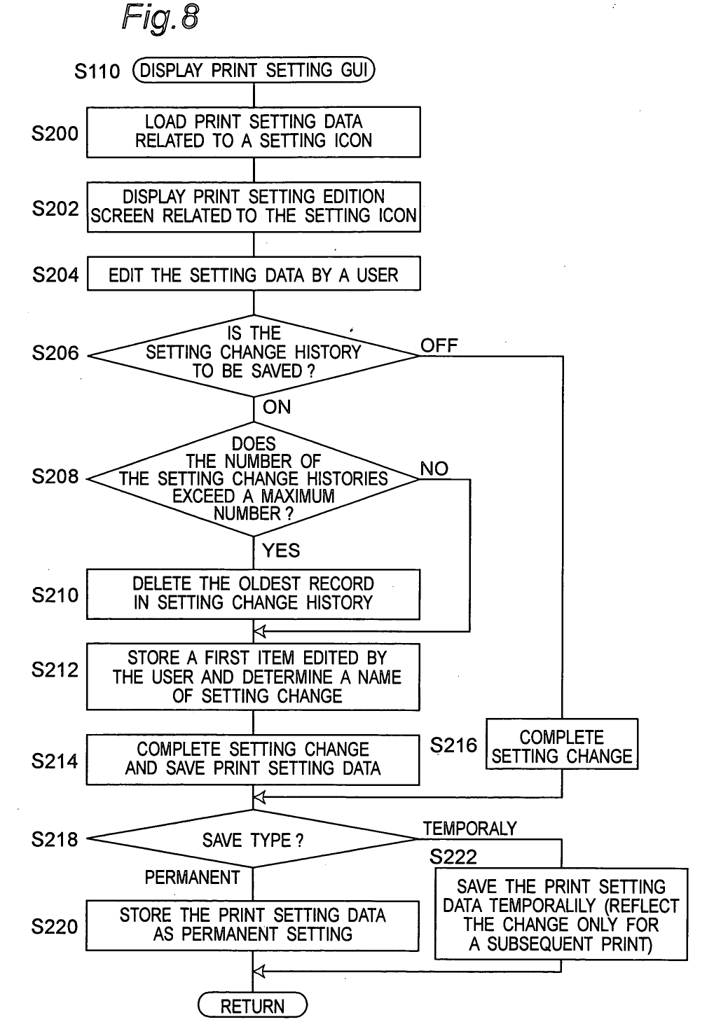

FIG. 8 is a flowchart of the display of the print setting graphic user interface (GUI) (S110 in FIG. 4) mentioned above. First, print setting data related to the setting icon is loaded (S200), and the print setting edition GUI reflecting the print data is displayed in the screen (S202). Then, the print setting is edited in the screen by the user according to the user's inputs (S204). When the user press the “save” button or “temporal save” button, it is checked whether the “save setting change history” is checked or not (S206). If the “save setting change history” is checked (ON at S206), and the number of records in the setting change history is larger than a maximum number (YES at S208), the oldest record is deleted (S210). Then, the item edited first by the user is acquired, and a name for the setting change is determined based on the item (S212). Thus, the setting change is completed, and the print setting data is stored in the setting change history storage section 56 (S214). On the other hand, when the “save setting change history” is not checked (OFF at S206), the setting change is completed (S216).

Then the flow branches according to a type for saving the print setting data (S218). In the case of the permanent setting (or when the “save” button shown in FIG. 6 is pressed), the print setting data is saved as a permanent setting (S220). Meanwhile, in the case of the temporal setting (or when the “temporal save” button shown in FIG. 6 is pressed), the print setting data is saved as a temporal setting (S222), so that the changed print setting data is used only for a subsequent printing.

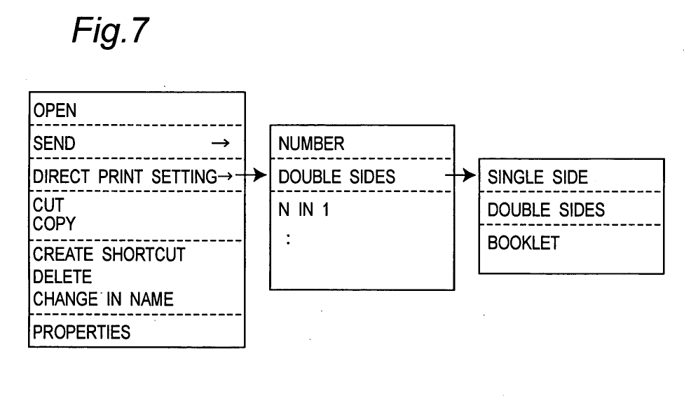

In the above-mentioned example, a print setting is edited by a double-click with the mouse. However, it may be directly edited by a right click. That is, when a setting icon is right-clicked, items and options which can be set are obtained from an application, and they are displayed in the screen. In an example shown in FIG. 7, “single side” printing is selected in menu items of “double sides”. The history or the like may be displayed further.

Next, an operation in correspondence to a right click on the setting icon will be described. In this case, the transmission history of the printed jobs is displayed, and a file is reprinted or saved again with reference to the transmission history. This is explained further in detail hereinafter. The transmission history includes, for example, a file name, a date, a printer, contents of print setting, and a job status.

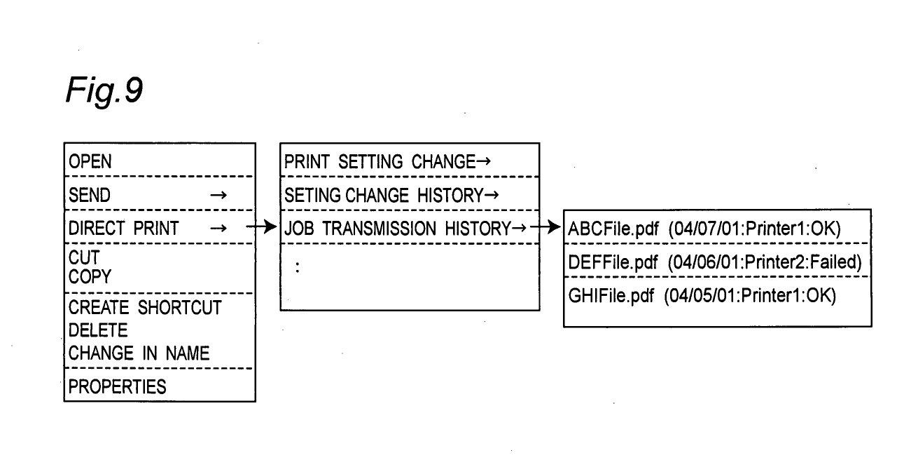

When the user right-clicks a setting icon, printed files are displayed. In an example of the display shown in FIG. 9, menu items such as “print setting change” (in correspondence to “direct print setting 1” in FIG. 7), “setting change history”, and “job transmission history” are displayed from a menu item of “direct print”. When the “job transmission history” is selected, files which store the job transmission histories are displayed. For example, in FIG. 9, “ABCFile.pdf” can be selected among these files. Here, when the job transmission history is displayed, a file name, a print date, a printer, a print setting and a job status are obtained from the print job stored in the print job history storage section 54, and a certain number of them are displayed as a list. When the user selects a file in the job transmission history list, the file can be printed again in the print setting in correspondence to the setting icon. The number of displayed files is three in FIG. 9, but it is not limited to three, and the user can set the number of files to be displayed optionally. In FIG. 9, the print date, the printer and the job status are displayed in addition to the file name. The display items may be set by the user optionally. In this example, because a setting icon corresponds to one printer in FIG. 9, only the jobs printed by the printer in correspondence to the setting icon may be displayed in the job transmission history.

When a file is selected in the job transmission history list, the file can be saved again. For example, after the file is designated, it may be displayed as a pop-up message for a user to select whether it is printed again or saved again. Alternatively, it may be previously selected by a checkbox, a radio button or the like in the setting in the application program.

As describe above, when a record of transmission history is selected in the screen of the transmission history of print job, the printing can be performed again with the print setting. This can be applied to a known icon of direct print (in general, a setting icon in correspondence to a registered print setting for a specified printer). When a record in the transmission history is selected by using such an icon, the printing can be performed again with the print setting selected.

Next, automatic save of a print setting change will be described. When the print setting is edited by direct edition on the print setting in correspondence to the setting icon, the changed print setting is saved. Here, a predetermined number of the print settings before this change are automatically saved, and a previous setting can be selected for printing. Not only in the case where a setting icon is edited directly and saved as a permanent setting, but also in the case where the print setting is saved temporally for a subsequent printing only, its history can be saved, displayed and selected.

As described above, when an edition record in the edition history is selected in the screen of the edition history of the setting for the setting icon, the printing can be performed again with the print setting. This can be applied to an icon itself for direct print well known in the art (or in general, a setting icon in correspondence to a registered print setting for a specified printer). When an edition history for such an icon is selected, the printing can be performed again with the print setting.

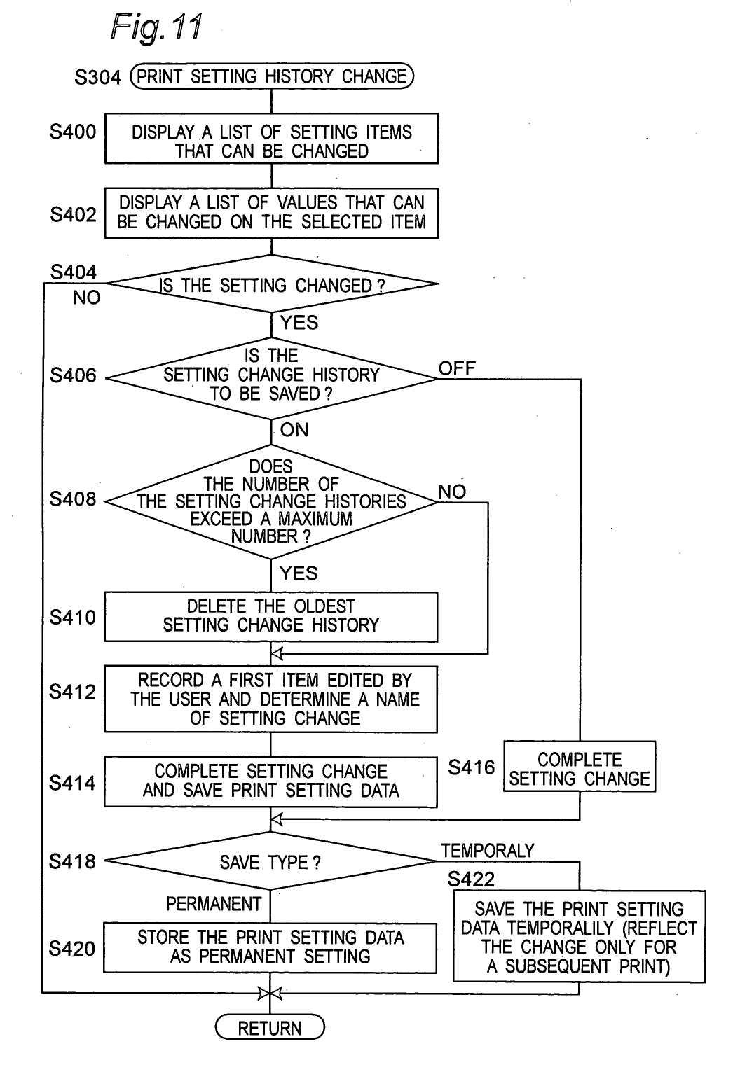

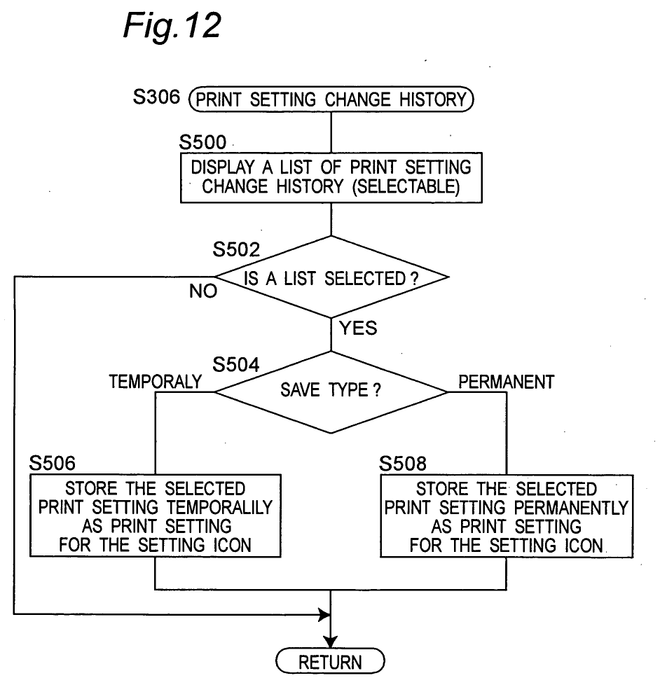

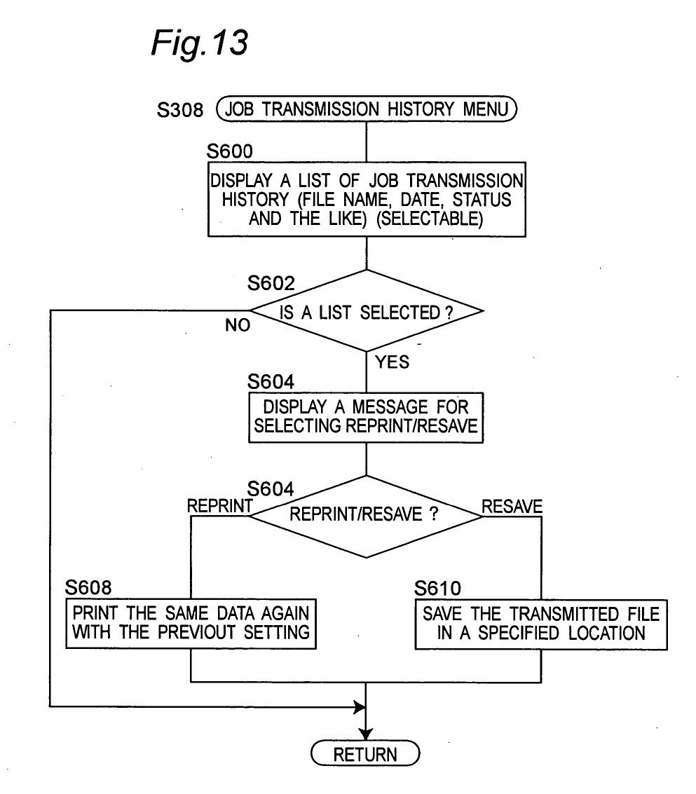

FIG. 10 is a flowchart of the print setting edition menu display, setting change history menu display and job transmission history menu display (S108 in FIG. 4) mentioned above. When a user right-clicks on a setting icon, a print setting edition menu, a setting change history menu, and a job transmission history menu are displayed (S300). Then, the flow branches according to the menu selected by the user (S302). When the print setting edition menu display is selected, a process for print setting change is performed (S304 in FIG. 11). When the setting change history menu display is selected, a process for the print setting change history is performed (S306 in FIG. 12). When the job transmission history menu is selected, a process for the job transmission history menu is performed (S308 in FIG. 13).

FIG. 11 is a flowchart of the print setting change (S304 in FIG. 10). First, a list of items in which the setting can be changed is displayed (S400). For example, number of copies, double sides, N_in_{—}1 and the like in FIG. 7 correspond to the above items in which the setting can be changed. A list of changeable values on an item selected by the user is displayed (S402). The user selects a desired changeable value among them. In FIG. 7, double sides, single side, and booklet correspond to the above changeable setting values.

When the user changes the setting (YES at S404), if the save of the setting change history is set (ON at S406), and the number of records in the setting change history is more than a predetermined maximum number (YES at S408), the oldest setting change record is deleted (S410). Then, the first edition item by the user is recorded, and a name for the setting change is determined based on the item (S412). Thus, the setting change is completed, and the print setting data is saved in the setting change history (S414). Meanwhile, when the save of the setting change history is not instructed by the user (OFF at S406), the setting change is completed (S416).

Then the flow branches according to the saving type of the print setting data (S418). When the saving type is permanent setting, the print setting data is saved permanently or as a default (S420). Meanwhile, when it is the temporal setting, the print setting data is saved temporally (S422) in which the changed print setting data is reflected only for a subsequent printing. When the setting is changed by the right click as explained above, either one of the permanent save and temporal save may be set like in FIG. 6 or it may be selected in a pop-up screen.

FIG. 12 is a flowchart of the process of the print setting change history (S306 in FIG. 10). First, a list of print settings in the print setting change history is displayed (S500). The user selects a desired print setting from the displayed print setting change history. When the user selects a print setting in the list (YES at S502), the flow branches according to save type (S504). When temporal setting is selected, the selected print setting is saved temporally as the print setting of this setting icon (S506). Meanwhile, when permanent setting is selected, the selected print setting is saved permanently as the setting of this setting icon (S508). In addition, when the setting change history is selected by a right-click as explained above, save or temporal save may be set, or it may be selected in the display of the pop-up screen.

FIG. 13 is a flowchart of the process of the job transmission history (S308 in FIG. 10). First, a list of the job transmission history is displayed (S600). Here, the file name, the date, the status and the like are displayed. The user selects a desired job in the displayed list of the job transmission history. When the user selects a job in the list (YES at S602), a selection message whether to reprint the data or to save the data again is displayed in the screen (S604). Then, the flow branches according to the selection of the user (S606). In the case of reprinting, the same data is printed again with the previous setting (S608). Therefore, the data once transmitted can easily be printed again in the same setting by the transmission history of the job. Meanwhile, in the case of saving again, the transmitted file is saved in a designated place (S610). In addition, the designated place may be a predetermined place or may be designated when the data is saved again. Thus, since the print setting change history and the transmission job history are automatically saved, the used setting can be easily reused and printed again even when they are not manually saved.

Next, the operation when the file icon is drag-and-dropped onto the setting icon will be described. In this case, the file is printed and the print setting is imported. A description will be made further in detail hereinafter.

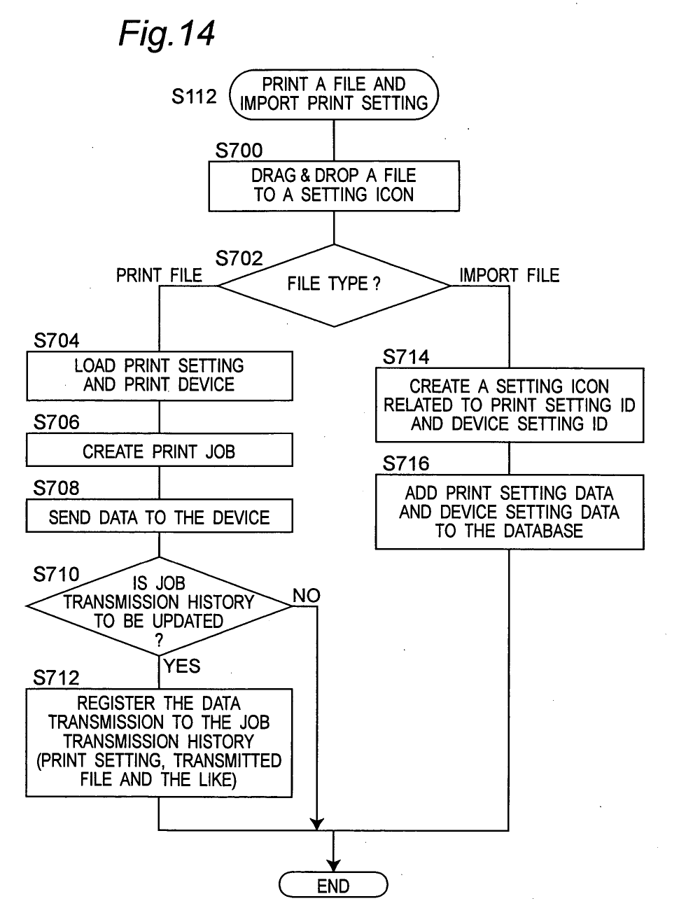

FIG. 14 is a flowchart of the printing of a file and the import of a print setting (S112 in FIG. 4). When the icon of the file is drag-and-dropped onto the setting icon (S700), the flow branches according to the identification of the file (S702). When the file is identified a print file (document file), the print setting in correspondence to the setting icon and ID or the like for specifying the printer are loaded (S704). Then, a print job for the file is created (S706), in which the present print setting (the setting after changed if it is changed temporally) is converted to commands, the print job consisting of the commands and the document file not converted. Then, the print job is transmitted to the printer 14 (S708). Then, when the job transmission history is ON, the print setting, the transmission file and the like are registered in the job transmission history (S710). Meanwhile, when the file is identified an import file, a setting icon related to the printing setting ID and the device setting ID is created (S712), and the print setting data and the device setting data are added to the database (S714).

Next, a most preferable example will be explained for using the print setting change history. As shown in FIG. 15, “setting change history” is displayed under the “current setting” (Duplex is added as its name), and when the user selects it, the setting change history is displayed on the right side as a list. In this example, “Stable 1 Point”, “2_in_{—}1”, and “Punch 2 Holes” are displayed. These names and the like displayed will be described below in detail.

When the setting change history menu as shown in FIG. 15 is displayed by a right-click on a setting icon, the menu may be so limited that they will not be selected if it is found, by obtaining the device information just before the display, that some items in the printing setting cannot be implemented. For example, if it is detected that there is no staples in the stapler by obtaining the device information just before the display, the menu of the “Staple Point” is grayed out, as shown in an example in FIG. 16. The menu items using stapling functions are all displayed with gray. In the example shown in FIG. 16, since the “2_in_{—}1” and the “Punch_{—}2_Holes” are not displayed with gray because they are menu items in which the stapling function is not used. Thus, since the setting which cannot be used again due to a status change in the printer cannot be selected, a defective printing can be prevented beforehand.

The above-mentioned acquisition of the status is explained below. When the setting change history menu is displayed by an operation such as a right click, an ID address is acquired from the device information, and information on mounted devices is acquired from the MIB information in the printer by SNMP communication. Here, for example, if the stapler is not mounted in the printer, ON/OFF information on the stapling in the print settings listed is checked as the change setting history, so that print settings in which the stapling function is ON cannot be selected. When it is OFF, it is displayed that the selection thereof is not allowed.

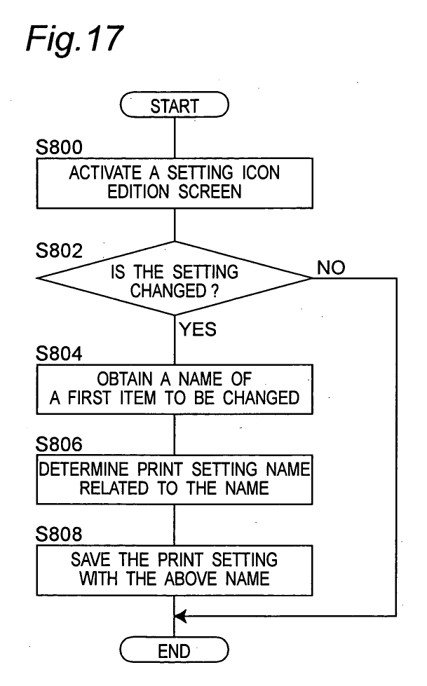

As described above, when the print setting is changed, the setting change history is stored, and it can be used by a right click on the setting icon. In this case, it is important that a user can select a print setting easily. In this embodiment, when a print setting is changed, a name for the print setting is saved automatically as will be described below with reference to a flowchart shown in FIG. 17. The screen shown in FIG. 7 and the print setting edition screen shown in FIG. 6 are displayed by a double click or a right click on the setting icon (S800). When the print setting is changed, the name (Staple_{—}1_Point, for example) of an item in the print setting changed first (a setting item changeable in FIG. 7) or a setting value changed (a changeable value in FIG. 7) is automatically acquired (S802). Next, a name for the print setting is automatically determined so as to be related to the name of the changed item or value (S804). The print setting name may be manually changed. Then, the print setting is saved with the determined name (S806).

When the setting is edited by a right click on the setting icon, or when the change is edited by a drag-and-drop of the file icon just before the printing, the print setting is saved together with the print setting name by the above automatic saving process in the setting change history storage section 56. When it is instructed to save a setting, if it is found that the same combination of the setting is already saved, it is not saved this time. The print setting name is determined with reference to the setting item changed first as mentioned above, because the setting item changed first is considered important in general and the user can easily understand a relation of the name with the contents in the print setting. That is, the user can easily select a print setting since the automatically saved print setting name is automatically given so as to be related to the setting item changed.

When the setting change history menu is displayed, a setting change history list having a predetermined number of history records is acquired from the database in the setting change history storage section 56. The list includes print setting names given automatically or edited manually and identifiers (setting change history ID) for identifying the setting change history records. As to the print setting selected from the menu display, the print setting is obtained after the selection from the “setting change history” database in correspondence to the setting change history ID. The obtained print setting is reflected in a subsequent printing or a change in the setting.

Next, an embodiment will be described in which a plurality of printing destinations are related to one setting icon. Here, information on printers and print settings to be transmitted to the printers is related and stored in one setting icon. When these print settings are used, the printers can perform printings in the respective print settings by one print instruction by a user. For example, a print setting 11a1 is set for a printer 10A, another print setting 11b3 is set for a printer 10B, a further print setting 11c3 is set for a printer 10C. They are all related to one setting icon 72. When an icon 74 of a file is drag-and-dropped onto the setting icon 72, the printings are performed in the respective printers in the respective print settings.

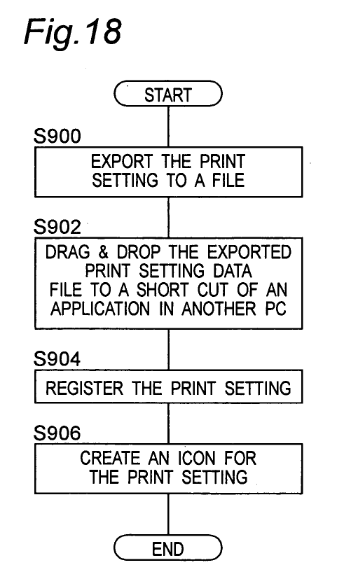

In addition, a print setting may be imported to create a setting icon. As shown in a flowchart in FIG. 18, a user exports a print setting to a file (S900). Then, when the user drag-and-drops the exported print setting data file onto a shortcut of an application in another computer (S902), its file name is reflected in the setting icon name and its data contents are reflected in the print setting contents when the data are registered (S904). Then, a setting icon of the print setting is created and displayed in the desktop (S906). This setting icon also has functions of directly activating the print setting edition screen, displaying the transmission history, automatically saving the print setting change history, and relating the print destinations to the print setting.

In the above-mentioned embodiments, it is advantageous that the print setting becomes easy because the print setting can be performed by drag-and-dropping a file icon of a document file onto any setting icon.

In addition, as explained above, a setting icon is allowed to have various kinds of functions such as edition, previously registering destinations and respective print settings, directly editing the print setting, saving and reprinting a print job history printed in each print setting, and saving automatically and using a change history of the print setting again. Thus, for example, the edition of the print setting can be directly performed on a screen visually, so that the edition becomes easy.

Furthermore, it is advantageous that the once transmitted printing can easily be repeated in the same setting by using the transmission history of the job. In addition, since the print setting change history is automatically saved, even when it is not saved manually by a user, the setting used before can easily be used again at the time of printing. Still further, since a name of the saved print setting is automatically given so as to relate it to the changed setting item, a user can easily select the print setting. In addition, a defective printing can be prevented beforehand since the setting which cannot be used again due to a change in status of the printer cannot be selected.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A print instruction program to be executed by an information processing apparatus for transmitting a print job to printers, comprising the steps of:
registering print settings for printers;
displaying a plurality of setting icons in correspondence to the print settings registered in a screen of a display device;
detecting that a file icon of a document file is drag-and-dropped onto a setting icon among the plurality of setting icons displayed in the screen; and
transmitting the document file in correspondence to the drag-and-dropped file icon and a setting command that was converted from the print setting corresponded to the setting icon on which the file icon is drag-and-dropped as the print job to a specified printer in correspondence to the setting icon.

2. The print instruction program according to claim 1, further comprising the step of displaying an edition screen for editing data of the print setting in correspondence to the setting icon in the screen when a predetermined operation on the setting icon is detected.

3. The print instruction program according to claim 2, further comprising the step of storing the print setting edited in the edition screen as the print setting data to be used permanently or temporally.

4. The print instruction program according to claim 1, further comprising the steps of:
storing a transmission history of the transmitted print job; and
displaying the stored transmission history when a predetermined operation on the setting icon is detected.

5. The print instruction program according to claim 1, further comprising the step of:
displaying an edition screen for editing the print setting in correspondence to the setting icon;
storing an edition history of the print setting;
detecting a predetermined operation for the setting icon; and
displaying the stored edition history when the predetermined operation for the setting icon is detected.

6. The print instruction program according to claim 1, wherein the setting icon corresponds to the plurality of the print settings, and in said transmitting step, each of the setting commands, which are corresponded to the plurality of settings respectively, are transmitted with the document file.

7. The print instruction program according to claim 1, further comprising the steps of:
exporting the print setting as a file in correspondence to the file icon in the screen;
importing the file by drag-and-dropping the file icon on an icon of an application installed in the information processing apparatus; and
creating a setting icon having the same contents in the print setting and the same name of the print setting.

8. A print instruction program to be executed by an information processing apparatus which transmits a print job to printers, comprising the steps of:
registering a print setting for a printer;
displaying a setting icon in correspondence to the print setting registered in a screen of a display device;
detecting that a file icon of a document file is drag-and-dropped onto the setting icon displayed in the screen;
transmitting the document file in correspondence to the drag-and-dropped file icon and a setting command that was converted from the print setting corresponded to the setting icon on which the file icon is drag-and-dropped as the print job to a specified printer in correspondence to the setting icon;
storing a transmission history of the transmitted print job; and
displaying the stored transmission history when a predetermined operation is detected.

9. A print instruction program to be executed by an information processing apparatus which transmits a print job to printers, comprising the steps of:
registering a print setting for a printer;
displaying a setting icon in correspondence to the print setting registered in a screen of a display device;
detecting that a file icon of a document file is drag-and-dropped onto the setting icon displayed in the screen;
transmitting the document file in correspondence to the drag-and-dropped file icon and a setting command that was converted from the print setting corresponded to the setting icon on which the file icon is drag-and-dropped as the print job to a specified printer in correspondence to the setting icon;
displaying an edition screen for editing the print setting in correspondence to the setting icon;
storing an edition history of the print setting;
detecting a predetermined operation for the setting icon; and
displaying the stored edition history when the predetermined operation for the setting icon is detected.

10. A print instruction method for transmitting a print job to a plurality of printers, comprising:
registering print settings for printers;
displaying a plurality of setting icons in correspondence to the print settings registered in a screen of a display device;
detecting that a file icon of a document file is drag-and-dropped onto a setting icon among the plurality of setting icons displayed in the screen; and
transmitting the document file in correspondence to the drag-and-dropped file icon and a setting command that was converted from the print setting corresponded to the setting icon on which the file icon is drag-and-dropped as the print job to a specified printer in correspondence to the setting icon.

11. A print instructor apparatus which transmits a print job to printers, comprising:
a register device which registers print settings for printers;
a display device which displays a plurality of setting icons in correspondence to the print settings registered in a screen of a display device;
a detector which detects that a file icon of a document file is drag-and-dropped onto a setting icon among the plurality of setting icons displayed in the screen; and
a transmitter which transmits the document file in correspondence to the drag-and-dropped file icon and a setting command that was converted from the print setting corresponded to the setting icon on which the file icon is drag-and-dropped as the print job to a specified printer in correspondence to the setting icon.
